(19) United States
(12) Patent Application Publication
(10) Pub. No.: US 2006/0243087 A1
(43) Pub. Date: Nov. 2, 2006

(54) Robot member

(75) Inventor: Arnulf Krogedal, Sandnes (NO)

Correspondence Address: VENABLE LLP, P.O. BOX 34385, WASHINGTON, DC, 20045-9998, US

(73) Assignee: ABB AS, Billingstad (NO)

(21) Appl. No.: 10/562,399

(22) PCT Filed: Jun. 24, 2004
(86) PCT No.: PCT/SE04/01040

§ 371 Date: Jun. 6, 2006

(30) Foreign Application Priority Data
Jun. 26, 2003 (EP) 03076990.5

(51) Int. Cl. B25J 17/00

(52) U.S. Cl. 74/490.05

(57) ABSTRACT

A robot wrist with a plurality of rotatable parts arranged in series with each other arranged to be mounted on a robot arm or automation machine to enable rotary movement of a first wrist part about a first axis and a second wrist part journalled in the first wrist part. Each wrist part may be arranged with one or more gear members to drive a rotary movement and rotate any wrist part relative to another wrist part. At least one gear member of one engaging pair is a concave bevel gear arranged with negative bevel angle to the plane of rotation at the engaging face. In another embodiment the robot wrist has three wrist parts. The robot wrist may also include an inner protection hose.

### TECHNICAL FIELD

The invention relates to a robot member comprising a journalled joint or wrist and to an industrial robot or other manipulator or automation machine provided with a said robot wrist.

### BACKGROUND ART

U.S. Pat. No. 4,690,012 and DE 3431033 entitled Robot wrist, describes a robot wrist for use with an industrial robot. Industrial robots are used to carry out a very wide range of industrial and/or commercial tasks quickly and accurately. In many applications, for example welding car bodies or painting automobiles, the robot must operate a tool such as an arc welding tip, paint sprayer or a gripper etc. within a confined space. U.S. Pat. No. 4,690,012 describes a robot wrist comprising three independently rotatable wrist parts. A first part is attached to the arm of a robot and rotates about a first axis, a second wrist part is rotatably attached to the first and arranged with gear pinions to rotate the second gear part about a second axis of rotation, and a third wrist part is similarly arranged rotatably mounted on the second part and drivable about a third axis of rotation.

The entire wrist section is formed so as to enclose a hollow space inside the wrist sections to allow positioning of other apparatus inside the wrists. In particular, the hollow interior of the wrist contains a protection hose, or other conduit, through which cables, wires, tubes or smaller hoses are arranged for supplying electric, compressed air or hydraulic power to one or more tools operated by the robot, and/or sending/receiving control signals or sensor data to or from the tool.

The robot wrist described above has a high degree of orientation, can access places inside hollow sections, box sections and has performed well in service. However, the hose inside the robot wrist containing the cables and other hoses tends to become worn in service due to the repeated flexing of the wrist parts, and such inner hoses require more frequent periodic maintenance or repair than would otherwise be desirable. Also, inclusion of power lines, control cables and the like inside the wrist sections is limited by the limited hollow space inside the robot wrist.

### SUMMARY OF THE INVENTION

The invention solves one or more of the above problems. The invention provides a hollow robot wrist with a plurality of rotatable parts arranged in series with each other, comprising at least a first wrist part arranged in use to be mounted to a robot arm or automation machine to enable rotary movement of the first wrist part about a first axis, a second wrist part journalled in the first wrist part, wherein each said wrist part is arranged with one or more gear members to drive a said rotary movement of any said wrist part relative to said another wrist part, wherein at least one pair of said gear members is arranged with a negative camber angle or negative bevel angle (Cₙ) to the plane of rotation (P) of said gear members.

In an advantageous embodiment of the invention the robot wrist comprises a first, a second and a third wrist part.

In another aspect of the invention a robot wrist is provided with an inner protection hose of an improved construction.

The principal advantage of the invention is a robot wrist with a relatively increased diameter of the hollow passage inside the wrist sections. There is relatively more free room inside the robot wrist for the protection hose (or other conduit) to bend and flex, compared to the prior art. Freer, less restricted bending and flexing results in less wear both to the protection hose and the cables, lines or other hoses inside it. This is an advantage which not only reduces wear and damage to cables and power supply wires etc. but also allows robot designers and operators more freedom in the choice and number of features and functions of the robot. This is because the size of the useable hollow space in the wrist section is significantly increased and thereby the potential functionality that can be accommodated.

The primary advantage of this type of robot wrist is that the robot can reach into partially enclosed spaces, such as into a hollow section or a box section of a car body to paint or treat a surface or to weld a joint etc. The improved functionality of the present invention allows the robot to reach into spaces that are too difficult for robots with prior art wrists to reach. The straight, compact shape and improved function provided by the invention increases the number and range of operations that can be cost-effectively carried out by industrial robots or manipulators. It means that more of the repetitive industrial tasks, for example machine tending operations such as supplying and/or removing components to a machine or other robot, and picking and/or packing operations such as picking up items and placing them in a container, may be handled by a robot equipped with a compact hollow robot wrist according to the invention.

The unique design and arrangement of the gear wheels also provides a wrist design that is very compact overall, and thereby offers a reduced outer diameter compared to other hollow wrist designs. This means that the robot wrist can reach into cavities or hollow sections through a smaller access window. A further advantage of the increased size of the inner cavity is that the protection hose bends freely, and does not extend in length in the bent position compared to the straight position, with decreased wear on the protection hose and the hoses, cables it contains. The inner protection hose may as well comprise an advantageous material with an extremely small coefficient of friction, to further reduce wear on the cables, hoses inside the protection hose. At the same time the exterior is more compact than prior art designs while maintaining great flexibility and providing an increased dimension for the inner hole or cavity.

The increased size of the inner hole or cavity is very advantageous because a robot used, for example, in painting applications or any other surface treatment applications, may have around 20 different lines installed inside the protection hose or conduit. Lines such as for supply of different paints, different colours, flushing lines, anti-corrosion fluids, de-greasing fluids, solvent lines, air lines, electrical power lines, electrical data connections. Similarly a robot used for welding may have lines for protective gases, flushing materials, fluxes, fluxing atmospheres, a welding wire feed, and so on. The increased space and the symmetrical shape of the space available inside the arm enable a longer service life for the lines, hoses and cables included inside the protection hose, with increased reliability and thereby productive up-time.

Another benefit is that the high degree of orientation capacity in at least two, and preferably three axes of movement provided by the advantageous embodiment of this robot wrist can be fully utilised when required without concern for increased wear of the protection hose or other lines arranged in the hollow space. Yet another advantage provided by the increased useable hollow space in the wrist is that access to the protection hose and other parts during maintenance service work or changes in production, is improved thus reducing down time, service time and set-up time during production changeovers.

### BRIEF DESCRIPTION OF THE DRAWINGS

A more complete understanding of the method and system of the present invention may be had by reference to the following detailed description when taken in conjunction with the accompanying drawings wherein:

FIG. 1 shows a robot wrist according to the Prior Art in a straight or extended position.

FIG. 2 shows the robot wrist according to the Prior Art in a bent position.

FIG. 3 shows a robot wrist according to an embodiment of the invention arranged with a hose and in a bent position.

FIG. 4 shows the robot wrist arranged with a hose and in a straight position;

FIG. 5 shows schematically the length of the hose in both a straight and a bent position of the robot wrist.

FIG. 6b shows a detail for the gearwheel design of the Prior Art and FIG. 6a shows a corresponding detail according to another aspect of the invention;

FIG. 7 shows a view in 3D of the exterior of the robot wrist in a straight position.

### DESCRIPTION OF THE PREFERRED EMBODIMENTS

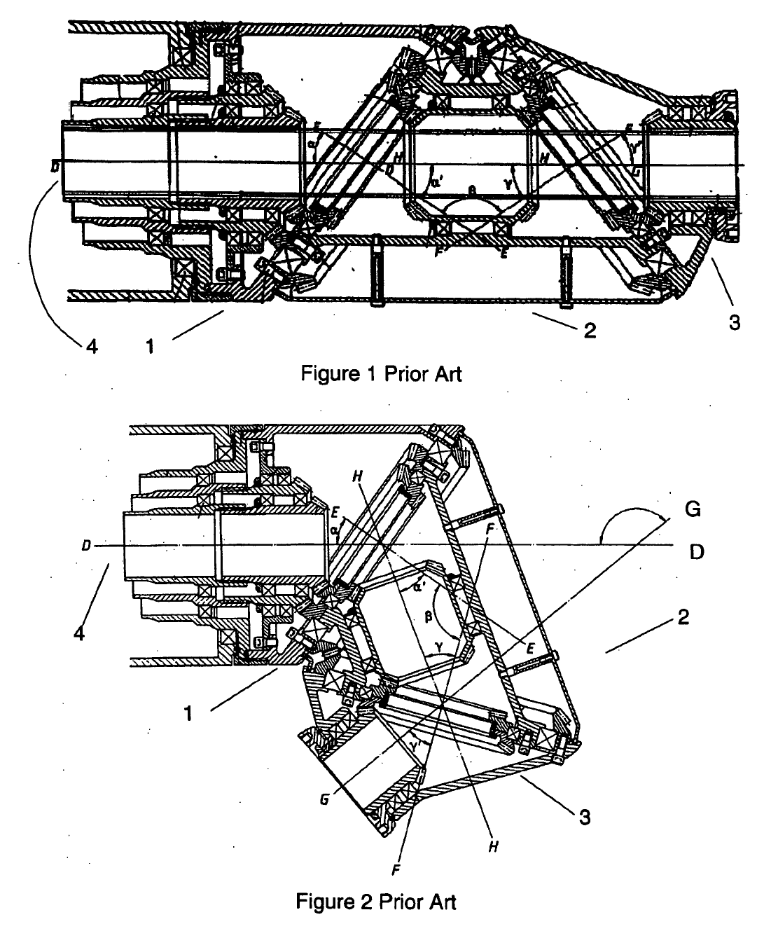

FIG. 1 (Prior Art) shows the robot wrist of U.S. Pat. No. 4,690,012 containing a protection hose and arranged in a straight position. The figure shows a first, second and third wrist parts 1, 2, 3. The axis of rotation for gear members between first and second wrist parts is indicated as A₁, and the axis of rotation for gear members arranged between second and third wrist part as A₂. The hollow structure contains a hose 4 arranged about a nominal centre line D. FIG. 2 shows the same wrist arranged in a bent position. The geometry of the hollow space in the Prior Art wrist design does not allow a free bending of the hose 4 which thereby imposes a limit on its service life. It may be said that the hose bends in two places while passing through the inside of the wrist in the fully bent position. The hose is also significantly extended in length when moving from a straight to bent configuration as indicated by the arrows marked x in the drawing.

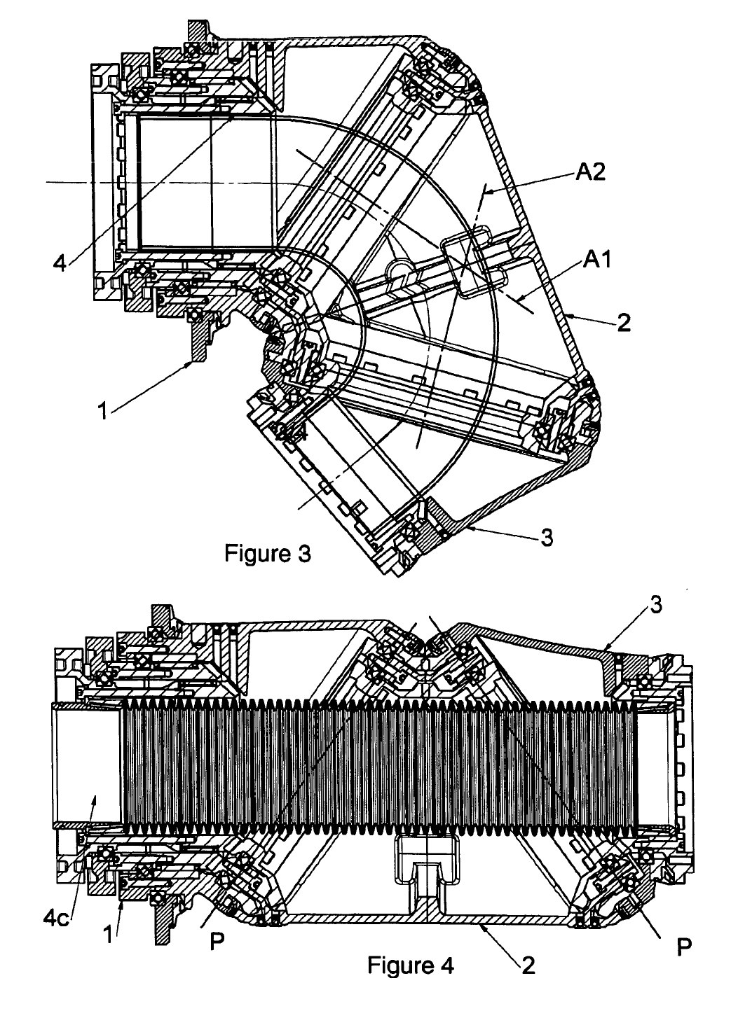

FIG. 3 shows schematically an embodiment according to the invention arranged in a bent position. The figure shows a first, second and third wrist parts 1, 2, 3 and a protection hose 4. The axis of rotation for gear members between first and second wrist parts is indicated as A₁, and the axis of rotation between second and third wrist part as A₂. According to the improved inner geometry of the robot wrist there are no obstacles to prevent symmetrical bending of the protection hose. It may be seen that the hose has a single bend only, forming a single circular arc to accomplish maximum bending while inside the wrist in the fully bent position.

The protection hose (and separate hoses and cables that may be included inside the protection hose but not shown in the figure) shown in FIG. 3 have the possibility to bend more freely than in the Prior Art design due principally to a redesigned gearwheel set-up. In the Prior Art design of FIG. 2 it is shown how the hose has to bend more than once in the existing design, and that the hose has to travel or extend over the linear distance X when bending from straight to bent position. The repeated travel and/or extension of the Prior Art design inflicts wear on the hoses. Wear on cables and lines inside the protection hose can also be severe, and this travel and/or extension is eliminated or at least to a great extent minimised by the invention.

A preferred embodiment of the present invention is shown in FIG. 4. The figure shows the same first, second and third wrist parts of the invention shown in FIG. 3 but arranged in a straight position. This may be compared to the equivalent Prior Art in FIG. 1. The plane of rotation of the gear members at either end of second (middle) wrist part 2 are indicated by a dashed line and the letter P. Each plane of rotation is perpendicular to the axis of rotation of each gear member, see A₁ and A₂ of FIG. 3. It can be seen that the second wrist part 2 in particular is more compact than the equivalent part 2 of the Prior Art. In other words, the small or apex-like side of the cylindrical second wrist part 2 of the invention is more compact than that of the prior art. The invention may be practised by means of the first wrist part and the second wrist part, with a tool of some sort directly attached to the second part. Preferably the invention is practised with three wrist parts in order to get the maximum extent of bending and thus ability to reach into difficult hollow sections, box sections. A protection hose 4c is shown which in this embodiment has a bellows or spiral shape.

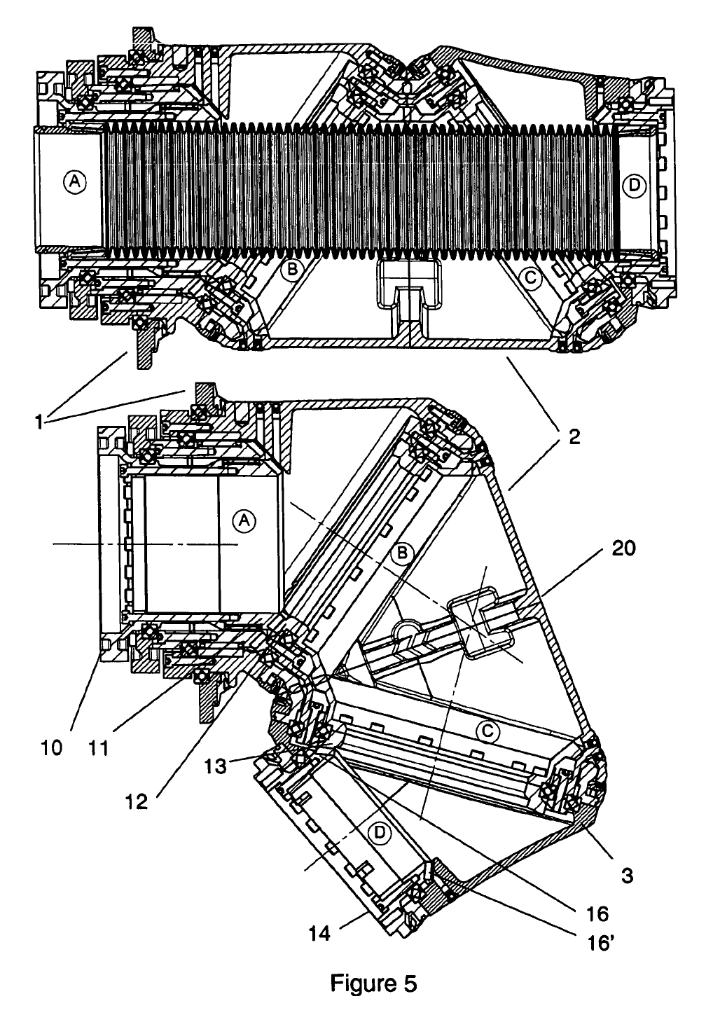

FIG. 5 shows a nominal centre line with points A, B, C, D which has a constant length during the bending of the wrist, otherwise described as bending the wrist triangle. In practice the inner protection hose has however a certain radius and it makes short cuts during bending. It also requires radiuses when changing directions. The improved inner hose of the invention allows the bending shortcuts to locally create extra length equal to the length of bending required for the local curve.

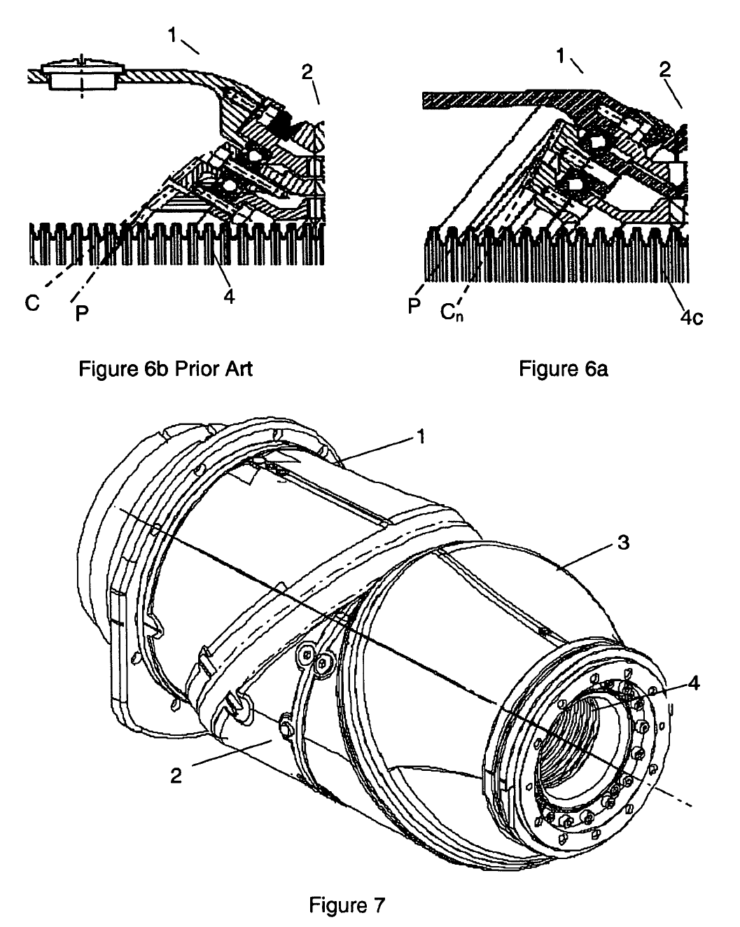

FIGS. 6b and 6a (Prior Art) show a structural difference between the gearwheel design of the prior art robot wrist version of U.S. Pat. No. 4,690,012 and the gearwheel design of the present invention. According to the invention specially designed annular bevel gears, which may alternatively be described or designed as gear members, gearwheels, ring gears, or bevel gears in which at least one of the meshing pair is a gearwheel design with negative bevel angle has provided an optimal condition for the inner hose and flexible movements of the inner hose in a compact design.

The particularly compact design shown is obtained by the special and unique arrangement and shape of the gear wheels inside the wrist. FIG. 6b shows a detail from the area of the joint and gearing between a first 1 and a second 2 wrist part according to the invention and FIG. 6a shows a similar detail of the Prior Art. It can be seen that the line along which the gears of the Prior Art mesh is inclined at a positive bevel angle by comparing line C with line P. In contrast, it can be seen that the mating faces of the invention of FIG. 6a looking at line Cₙ and the line of the plane of the bevel gears P that there is a negative bevel Cₙ on the gear face shown. The negative bevel angle for at least one gearwheel in the pair first wrist part/second wrist part has enabled the increased inner diameter of the wrist section and removed or reduced previous obstacles hindering free bending of the protection hose. It can be seen from the Prior Art detail of FIG. 6a or that there is no such negative bevel angle of the bevel gears. The inventors have found that a negative camber angle or bevel angle of around −10 degrees to be advantageous, although angles of −5 or so and of much greater than 12 are possible.

FIG. 7 shows an exterior and 3-d view of the robot wrist in which the first, second and third wrist parts 1, 2, 3 are indicated. A nominal centre line D is shown. Inside one end of the wrist, the third wrist part 3, a protection hose 4 in the form of a corrugated type hose is visible. Inside one end of the wrist the protection hose 4 is visible in the form of a corrugated and ring reinforced or spiral type hose.

As described above, the inner protective hose may contain a plurality of wires, hoses and cables, perhaps a total 20 or more. Extension of the single hoses and cables contained in the inner hose may also be minimised by arranging them in a predetermined pattern in the inner protection hose of the robot wrist before normal operations. By applying for example a predetermined twist, relative to the planned direction and degree of rotation of the wrist parts, it is possible to compensate for variation in length of the individual hoses and cables when the robot wrist rotates and bends during normal operations. For example, a twisted wire format of up to 180 degrees or more may be applied to at least some of the hoses and/or cables when they are installed inside the robot wrist.

In another, preferred embodiment, the inner hose is a flexible articulated hose of the type shown in FIG. 4. Superior bending characteristics are obtained by a hose with this type of articulation or bellows form that supports symmetric bending. This type of articulated inner hose tends to bend under applied force in a circularly symmetrical shape. Other, non-circular geometries are also possible for robot wrists with an inner geometry that requires different bending behaviour. The structure of the hose may comprise a single phase plastic material or a layered plastic material.

Elastomeric, other polymeric or composite materials may be used. The plastic material may comprise in part a fluoropolymer, such as the plastic polytetrafluorethylene (PTFE) commonly referred to by the trademark name Teflon (Trade mark of DuPont Inc.), or other fluoropolymer in a blend, copolymer, composite or layered structure. The use of a friction reducing material such as the fluoropolymer greatly reduces any friction between the inside of the protection hose and the wires, cables, hoses etc it contains. Preferably the structure comprises at least two phases and includes reinforcing elements of a different diameter, such as metal rings or plastic rings. The metal rings may in an alternative embodiment be arranged as a continuous spiral or helix of wire arranged towards the outside, or arranged around the outside, of a plastic hose that is moulded to a corrugated form in contrast to a plastic hose combined with discrete rings. The wire rings or spiral may also be covered by a layer of plastic which may be thin.

It should be noted that while the above describes exemplifying embodiments of the invention, there are several variations and modifications which may be made to the disclosed solution without departing from the scope of the present invention as defined in the appended claims.

In a further embodiment, the positive bevel angle of one gear of a pair, a convex bevel gear, may be of a reduced positive angel, compared to the other of the pair. In a still further embodiment, the positive angle of one gear member of a pair may be reduced to zero, and thus have a flat or neutral bevel angle. The second gear of the pair may have a positive gear angle such as is typical for a convex bevel gear.

FIGS. 3, 4 and 5 shows the preferred embodiment, with at least one gear of a meshing pair having a negative bevel angle, in other words, being a concave (or neutral) bevel gear. This embodiment is also a hollow wrist device capable of bending from a straight position where the hollow space may comprise a straight cylindrical space from A to D, as exemplified eg in FIGS. 3, 4, 5, 7. FIG. 4 shows the three parts 1, 2, 3 of the wrist and a protection hose 4. It may be seen that the second part 2 of the wrist is formed by fixing together two separate parts, as indicated by a split line 20 in FIG. 4 and shown without reference numbers in FIGS. 3, 5 and 7. Making the second part 2 from two parts that are subsequently fixed together facilitates the construction and mounting of the parts each comprising a bevel gear shown as B and C of FIG. 5 into the very compact structure of the second part 2.

FIG. 4 also shows that the axial centre lines A1, A2 of the two members of second wrist part 2 intersect within the boundary wall of the hose 4, and closer to the centre of radius of bending of the arm, when compared to the prior art of FIGS. 1, 2 in which the intersection of axes E-E, F-F corresponding to A1, A2 of FIGS. 3, 8, 10 falls outside the protection hose 4 and much further away from the centre of radius of the bend.

FIG. 5 has been arranged with reference numbers to show one or more meshing gear pairs wherein at least one gear is arranged with a negative gear angle or is a concave bevel gear. FIG. 5 shows an inner part 10 of the first part 1 arranged with a bevel gear with a positive gear angle and marked 11. Gear 11 meshes with a negative gear angle 12 of a gear member arranged in the second part 2, around centre line B. The other side (C) of second part 2 engages and may drive an inner member 14 of the third part 3. Inner member 14 is shown in cross section and it engages with a positive gear angle or convex bevel gear teeth 16 with gear member 13 which has a negative gear angle, a concave bevel gear. The convex bevel gear of 14 is clearly seen in the cross section at 16′ on the other side of the centre line D.

The compact arrangement and design of the second wrist part 2 also results in that drive to axis 6, the tool holding end, ie gear member 14 in wrist part 3, is transmitted from the robot arm end 1 directly from a member 10 of the first part to a member 12 of the second part, from a second member 13 to a member 14 of the third part 3 directly, without an additional drive transfer means such as the journalled tubular gear member or support member visible in the centre of the second part of FIGS. 1, 2 from the prior art. Thus drive is transferred, as in the other embodiments, through part of the housing of second part 2 to the second gear member 13 which may then drive a tool directly in a two-part embodiment or drive a gear member of a third wrist part as shown in FIGS. 3-5, and 7 such as 14 of the third part. Power transferring gear members 13 and 14 of the second part are shown arranged inclined to one another, ie with their axes of rotation A1, A2 inclined at an angle to one another and not parallel to each other.

1. A robot wrist with a plurality of rotatable parts arranged in series with each other, comprising
at least a first wrist part arranged in use to be mounted to a robot arm or automation machine to enable rotary movement of the first wrist part about a first axis,
a second wrist part journalled in the first wrist part, wherein each wrist part is arranged with one or more gear members to drive a said rotary movement of any said wrist part relative to said another wrist part, and
a concave bevel gear arranged at a generatrix of the conical surface of least one of said gear members said concave bevel gear having a negative bevel angle relative to a plane perpendicular to the rotation axis of said gear member.

2. The robot wrist according to claim 1, wherein at least one of said gear members is arranged with a convex bevel gear with a positive bevel angle relative to a plane perpendicular to the rotation axis and at least one other said gear member is arranged as a concave bevel gear with a negative bevel angle.

3. The robot wrist according to claim 1, wherein the negative bevel angle lies in the range between 0 and −20 degrees.

4. A The robot wrist according to claim 1, wherein the negative bevel angle (Cn) lies in the range between −8 and −12 degrees.

5. A The robot wrist according to claim 1, wherein the gear member is an annular bevel gear.

6. A The robot wrist according to claim 1, wherein said second wrist part is arranged with a said gear member with the negative bevel angle.

7. The robot wrist according to claim 4, wherein the negative bevel angle of the gear member of said second wrist part is arranged to engage a gear member of said first wrist part.

8. The robot wrist according to claim 1, wherein each of said gear members has a hollow opening through which an inner protection hose is arranged.

9. The robot wrist according to claim 8, wherein the inner protection hose is arranged so as to pass through the inside of the wrist parts arranged in a single circular arc when the wrist is in a bent position.

10. The robot wrist according to claim 8, wherein the inner protection hose passing through the inside of the wrist parts has the same total length when arranged in each of a bent and a straight position.

11. The robot wrist according to claim 8, wherein the inner protection hose is a hose with a substantially cylindrical wall.

12. The robot wrist according to claim 11, wherein the inner protection hose is a hose with a cylindrical wall that has a straight and parallel wall cross-section.

13. The robot wrist according to claim 12, wherein the inner protection hose is a hose with a wall cross-section in the form of a wave.

14. The robot wrist according to claim 12, wherein the inner protection hose comprises an articulated hose comprising circular sections of at least two different diameters.

15. The robot wrist according to claim 13, wherein the inner protection hose is formed of a polymeric material combined with at least one metal reinforcing member.

16. The robot wrist according to claim 15, wherein the inner protection hose comprises a fluoropolymer.

17. The robot wrist according to claim 15, wherein the metal reinforcing member comprises a plurality of metal rings.

18. The robot wrist according to claim 13, wherein the metal reinforcing member comprises any of a spiral wire or a helical wire.

19. The robot wrist according to claim 18, wherein the metal rings, spiral wire or helical wire of the hose are attached to the outside surface of the polymeric material.

20. The robot wrist according to claim 18, wherein the rings, spiral wire or helical wire of the hose are embedded in the polymeric material.

21. The robot wrist according to claim 1, wherein a plurality of hoses and/or cables are arranged inside said inner protection hose inside the wrist parts.

22. The robot wrist according to claim 21, wherein the plurality of hoses and/or cables are twisted to a predetermined extent inside the inner protection hose and comprise any from the list of: hose, wire, feed rod, cable.

23. The robot wrist according to claim 22, wherein the plurality of hoses and/or cables are arranged installed inside the robot wrist twisted to a predetermined extent through 180 degrees.

24. A The robot wrist according to claim 1, wherein the negative bevel angle of gear member of said second wrist part is arranged facing a third wrist part.

25. The robot wrist according to claim 24, wherein the third wrist part is journalled in the second wrist part to enable rotary movement of the third wrist part relative the second wrist and the second wrist part relative the first.

26. A The robot wrist according to claim 1, wherein a gear member of the first part is arranged to engage a gear member of the second part such that the second wrist part transfers effect to rotatably drive a gear member of the third wrist part engaged by a second gear member of the second part.

27. The robot wrist according to claim 26, wherein the second part gear members transferring effect to the third part gear member are arranged in the second part such that their axes of rotation are at an inclined angle to each other.

28. The robot wrist according to claim 26, wherein a first part gear member and a third part gear member are convex bevel gears with a positive gear angle and a second part gear member is a concave bevel gear with a negative bevel angle.

29. Use of a robot wrist according to claim 1 for an internal or an external surface treatment operation or painting operation with an industrial robot.

30. Use of a robot wrist according to claim 1 for a welding operation with an industrial robot.

31. Use of a robot wrist according to claim 1 for a picking and/or packing operation with an industrial robot.

32. Use of a robot wrist according to claim 1 for a machine tending operation with an industrial robot.
